(19) United States
(12) Patent Application Publication
(10) Pub. No.: US 2008/0181488 A1
(43) Pub. Date: Jul. 31, 2008

(54) CAMERA CALIBRATION DEVICE, CAMERA CALIBRATION METHOD, AND VEHICLE HAVING THE CALIBRATION DEVICE

(75) Inventors: Yohei ISHII, Osaka City (JP); Hiroshi KANO, Kyotanabe City (JP); Keisuke ASARI, Katano City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 12/023,407

(22) Filed: Jan. 31, 2008

(30) Foreign Application Priority Data
Jan. 31, 2007 (JP) JP2007-020495

(51) Int. Cl. G06K 9/00

(52) U.S. Cl. 382/154

(57) ABSTRACT

Cameras are installed at the front, right, left, and back side of a vehicle, and two feature points are located at each of the common field of view areas between the front-right cameras, front-left cameras, back-right cameras, and back-left cameras. A camera calibration device includes a parameter extraction unit for extracting transformation parameters for projecting each camera's captured image on the ground and synthesizing them. After transformation parameters for the left and right cameras are obtained by a perspective projection transformation, transformation parameters for the front and back cameras are obtained by a planar projective transformation so as to accommodate transformation parameters for the front and back cameras with the transformation parameters for the left and right cameras.

### CROSS REFERENCE TO RELATED APPLICATIONS

This application claims priority based on 35 USC 119 from prior Japanese Patent Application No. P2007-020495 filed on Jan. 31, 2007, the entire contents of which are incorporated herein by reference.

### BACKGROUND OF THE INVENTION

1. Field of the Invention

This invention relates generally to image processing, and more particularly to a camera calibration device and a camera calibration method which calibrates images from different cameras mounted at different positions with respect to each other, to combine the images and to project the combined image on a predetermined plane. This invention also relates to a vehicle utilizing such a calibration device and method.

2. Description of Related Art

With growing safety awareness of recent years, increased use has been made of a camera being mounted on a vehicle such as an automobile, or an on-vehicle camera, to provide an operation with increased visual awareness around the vehicle. Also, researches have been made to display images by image processing technologies that are more meaningful rather than simply displaying the raw images taken by each camera of a multi-camera system. One of such technologies is to generate and display bird's eye view images that reorient the images as being viewed from above, by coordinate transformations of the captured images. Displaying such bird's eye view images makes it easier for a driver to visualize the conditions surrounding the vehicle.

There also has been a visibility support system developed for converting images captured by multiple cameras to a 360° bird's eye view image by geometric conversions and displaying it on a display device. Such a visibility support system has advantages that it can present 360° conditions surrounding the vehicle to a driver in the form of an image viewed from above, covering the 360 degrees around the vehicle by which any blind spots can be eliminated.

FIG. 1 shows a top plan view of a vehicle in which this kind of visibility support system is applied. At each of the front, back, left and right side of the vehicle, a front camera 1F, a back camera 1B, a left camera 1L, and a right camera 1R are respectively arranged. In this visibility support system, a synthesized 360° bird's eye view image is generated and displayed by projecting the captured image by each camera on a common plane, such as the ground, and combining them by coordinate transformations. FIG. 2 shows a schematic view of a displayed 360° bird's eye view image 900. In the 360° bird's eye view image 900, bird's eye view images based on captured images of the cameras 1F, 1R, 1L, and 1B respectively are represented at the front side, right side, left side, and back side of the vehicle.

Methods to transform a captured image of a camera to a bird's eye view image are known from a technique based on a perspective projection transformation such as shown in Japanese Patent Laid-Open No. 2006-287892 and a technique based on a planar projective transformation such as shown in Japanese Patent Laid-Open No. 2006-148745. In either technique, it is necessary to adjust transformation parameters for the coordinate transformations appropriately to synthesize the junctions of the images without distortion.

In the perspective projection transformation, transformation parameters are computed to project a captured image onto a predetermined plane (such as a road surface) based on external information of a camera such as a mounting angle of the camera and an installation height of the camera, and internal information of the camera such as a focal distance (or a field angle) of the camera. Therefore, it is necessary to accurately determine the external information of the camera in order to perform coordinate transformations with high accuracy. While the mounting angle of the camera and the installation height of the camera are often designed beforehand, errors may occur between such designed values and the actual values when a camera is installed on a vehicle, and therefore, it is often difficult to measure or estimate accurate transformation parameters.

In the planar projective transformation, a calibration pattern is placed within an image-taking region, and based on the captured calibration pattern, the calibration procedure is performed by obtaining a transformation matrix that indicates a correspondence relationship between coordinates of the captured image (two-dimensional camera coordinates) and coordinates of the transformed image (two-dimensional world coordinates). This transformation matrix is generally called a homography matrix. The planar projective transformation does not require external or internal information of the camera, and the corresponding coordinates are specified between the captured image and the converted image based on the calibration pattern that was actually captured by a camera, and therefore, the planar projective transformation is not affected by camera installation errors, or is less subject to camera installation errors. Japanese Laid-Open No. 2004-342067 discloses a technique to adjust transformation parameters based on the planar projective transformation by images captured at multiple locations (see e.g. paragraph 69 in particular).

The homography matrix for projecting each camera's captured image onto the ground can be computed based on at least four feature points having known coordinate values. In order to combine captured images of multiple cameras onto a common synthesized image, however, it is necessary to provide the feature points for each camera on a common two-dimensional coordinate system. In other words, it is necessary to define a common two-dimensional coordinate system for all of the cameras as shown in FIG. 3 and to designate coordinate values of the at least four feature points on this two-dimensional coordinate system for each camera.

When providing multiple cameras on a vehicle such as a truck and calibrating each of the cameras to obtain a 360° bird's eye view image, therefore, it is necessary to provide an enormous calibration pattern that encompasses all the fields of view of the multiple cameras. In an example as shown in FIG. 3, a grid-like calibration pattern that covers all the fields of view of the cameras is provided around the vehicle, and intersecting points of the grid are used as the feature points. The size of such a calibration pattern for example is twice that of the horizontal and vertical sizes of the vehicle, occupying a large space for the calibration procedure and requiring high maintenance of the calibration environment, which increases the burden for the calibration operation as a whole. A more convenient calibration method, therefore, would be desirable to improve efficiency of the calibration operation.

As described above, when the perspective projection transformation is used, errors with respect to known setup information such as installation errors of the camera have a considerable effect. On the other hand, when the planar projective transformation is used, it is highly burdensome to maintain the calibration environment.

### SUMMARY OF THE INVENTION

One object of this invention, therefore, is to provide a camera calibration device and a camera calibration method that can reduce image degradation caused by errors with respect to known setup information and that can contribute to facilitating maintenance of the calibration environment. Another object is to provide a vehicle utilizing such a camera calibration device and method.

In order to achieve the above objects, one aspect of the invention provides a camera calibration device having a parameter extraction unit that obtains parameters to project each captured image of a plurality of cameras onto a predetermined plane and synthesize them; in which the plurality of cameras include at least one reference camera and at least one non-reference camera; in which the parameters include a first parameter for the reference camera and a second parameter for the non-reference camera; and in which the parameter extraction unit obtains the second parameter based on the first parameter and captured results of a calibration marker captured by the reference camera and by the non-reference camera, the calibration maker being located within a common field of view that is commonly captured by the reference camera and the non-reference camera.

According to this aspect, it is only necessary to position the calibration marker within a common field of view that is commonly captured by the reference camera and the non-reference camera. Moreover, while the first parameter is subject to the influence of errors with respect to the setup information (such as installation errors of the cameras), such influence by the errors can be absorbed by the second parameter side, because the second parameter is obtained based on the captured results of the calibration marker and the first parameter. The image is synthesized based on the first parameter that is subject to errors with respect to the setup information and the second parameter that can absorb such errors, and therefore, it becomes possible to obtain an image with less distortion at the junctions of the images being synthesized.

For example, the first parameter is obtained based on the perspective projection transformation using the setup information.

At least four feature points, for example, are set up within the common field of view by positioning the calibration marker, and the parameter extraction unit obtains the second parameter based on captured results of each of the feature points by the reference camera and by the non-reference camera and the first parameter.

Also, the parameter extraction unit can extract the second parameter without imposing any restraint conditions on the positioning of the calibration marker within the common field of view. Therefore, it can simplify the maintenance of the calibration environment immensely.

Also, the parameter extraction unit may include a first parameter correction unit that corrects the first parameter based on a captured result of a calibration pattern by the reference camera, the calibration pattern having a known configuration and being located within a field of view of the reference camera; and the parameter extraction unit obtains the second parameter using the first parameter corrected by the first parameter correction unit. This configuration makes it possible to reduce the influence of errors with respect to the setup information further.

Another aspect of the invention provides a vehicle having a plurality of cameras and an image processing unit installed therein, in which the image processing unit includes a camera calibration device having the above-described features.

Still another aspect of the invention provides a camera calibration method that obtains parameters to project each captured image of a plurality of cameras onto a predetermined plane and synthesize them, in which the plurality of cameras include at least one reference camera and at least one non-reference camera; in which the parameters include a first parameter for the reference camera which is obtained based on known setup information, and a second parameter for the non-reference camera; and in which the camera calibration method obtains the second parameter based on captured results of a calibration marker by the reference camera and the non-reference camera and the first parameter, the calibration maker being located within a common field of view that is commonly captured by the reference camera and the non-reference camera.

### BRIEF DESCRIPTION OF THE DRAWINGS

FIG. 1 is a plan view showing a conventional camera setup condition on a vehicle in which a visibility support system is applied;

FIG. 2 is a schematic view showing a condition of a 360° bird's eye view image displayed by a conventional visibility support system;

FIG. 3 is a schematic view for explaining a conventional calibration operation corresponding to a planar projective transformation, showing a coordinate system or a calibration pattern commonly defined for a plurality of cameras;

FIG. 4 is a plan view of a vehicle in which a visibility support system according to one embodiment of the invention is applied, showing an installation condition of each camera on the vehicle;

FIG. 5 is a perspective view of the vehicle of FIG. 4 viewed obliquely from the front-left side;

FIGS. 6A to 6D are schematic views showing a field of view of each camera installed in the vehicle of FIG. 4;

FIG. 7 is a schematic view showing all of the field of views captured by the cameras installed in the vehicle of FIG. 4 being put together;

FIG. 8 is a block diagram showing a configuration of the visibility support system according to the embodiment of the invention;

FIG. 9 is a schematic view showing bird's eye view images obtained from images captured by the cameras of FIG. 4 respectively;

FIG. 10 is a schematic view showing a 360° bird's eye view in which the bird's eye view images of FIG. 9 are synthesized;

FIG. 11 is a flowchart showing a calibration processing procedure according to the first embodiment of the invention;

FIG. 12 shows an installation condition of the cameras of FIG. 4 onto the vehicle;

FIG. 13 is a plan view of a marker located within each of the common field of views of FIG. 7;

FIG. 14 is a plan view of the vehicle periphery showing an arrangement of each marker (feature points) according to the first embodiment of the invention;

FIGS. 15A and 15B show a corresponding relation of coordinate values of the feature points used in the planar projective transformation according to the first embodiment of the invention;

FIG. 16 is a plan view of the vehicle periphery showing an arrangement of each marker (feature points) according to the second embodiment of the invention;

FIG. 17 is a flowchart showing a calibration processing procedure according to the second embodiment of the invention;

FIG. 18 is a flowchart showing a generalized calibration processing procedure according to the second embodiment of the invention;

FIG. 19 is a schematic view for explaining the generalized calibration processing procedure according to the second embodiment of the invention;

FIG. 20 is a plan view of the vehicle periphery showing an arrangement of each calibration pattern according to the third embodiment of the invention;

FIG. 21 is a plan view of a calibration plate on which the calibration pattern according to the third embodiment of the invention is drawn;

FIG. 22 is a flowchart showing a calibration processing procedure according to the third embodiment of the invention;

FIG. 23 shows projection errors derived from camera setup information errors concerning the third embodiment of the invention; and

FIG. 24 is a schematic view showing a relation between a captured image and a bird's eye view image.

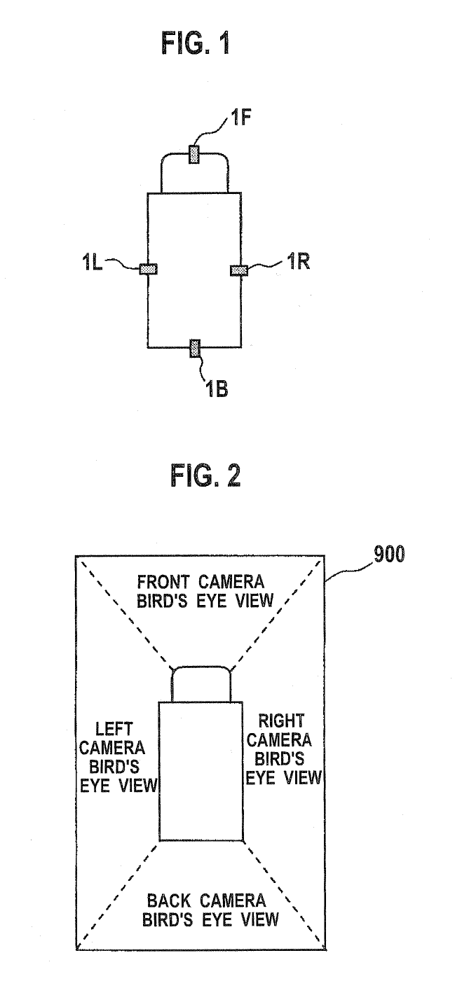

### DETAILED DESCRIPTION OF EMBODIMENTS

Preferred embodiments of the invention will be described below with reference to the accompanying drawings. The same reference numbers are assigned to the same parts in each of the drawings being referred to, and overlapping explanations for the same parts are omitted in principle.

### First Embodiment

The first embodiment now will be explained. FIG. 4 is a plan view showing a vehicle 100 viewed from above in which a visibility support system of the first embodiment is applied, showing an arrangement of cameras on the vehicle 100. FIG. 5 is a perspective view of the vehicle 100 viewed obliquely from the front-left side. Although a truck is shown as the vehicle 100 in FIGS. 4 and 5, the vehicle 100 can be any other vehicle such as a regular passenger automobile. Also, the vehicle 100 is located on the ground such as a road surface. In the following explanations, the ground is assumed to be a horizontal plane and the “height” indicates a height with respect to the ground.

As shown in FIG. 4, cameras (image pickup devices) 1F, 1R, 1L, and 1B are mounted at the front part, the right side part, the left side part, and the back part of the vehicle 100 respectively. The cameras 1F, 1R, 1L, and 1B simply may be referred to as the cameras or each camera without being distinguished from each other. Also, as shown in FIG. 5, the camera 1F is placed for example at the top of the front mirror of the vehicle 100, and the camera 1L is placed at the upper most part of the left side face of the vehicle 100. Although not shown in FIG. 5, the camera 1B is placed for example at the upper most part of the back part of the vehicle 100, and the camera 1R is placed for example at the upper most part of the right side face of the vehicle 100.

The cameras 1F, 1R, 1L, and 1B are arranged on the vehicle 100 such that an optical axis of the camera 1F is directed obliquely downward towards the forward direction of the vehicle 100; an optical axis of the camera 1B is directed obliquely downward towards the backward direction of the vehicle 100; an optical axis of the camera 1L is directed obliquely downward towards the leftward direction of the vehicle 100; and an optical axis of the camera 1R is directed obliquely downward towards the rightward direction of the vehicle 100. In FIG. 5, a field of view of each camera, i.e. spatial region of which each camera can capture an image, is shown. The fields of view of the cameras 1F, 1R, 1L, and 1B are shown as 2F, 2R, 2L, and 2B respectively. As for the fields of view 2R and 2B, only a portion thereof is shown in FIG. 5.

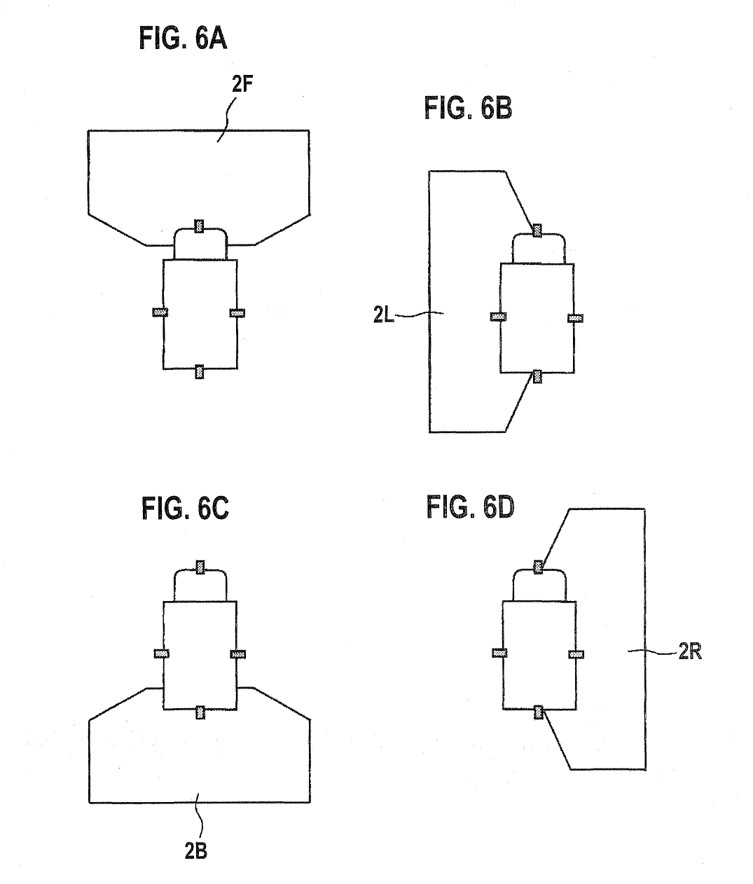

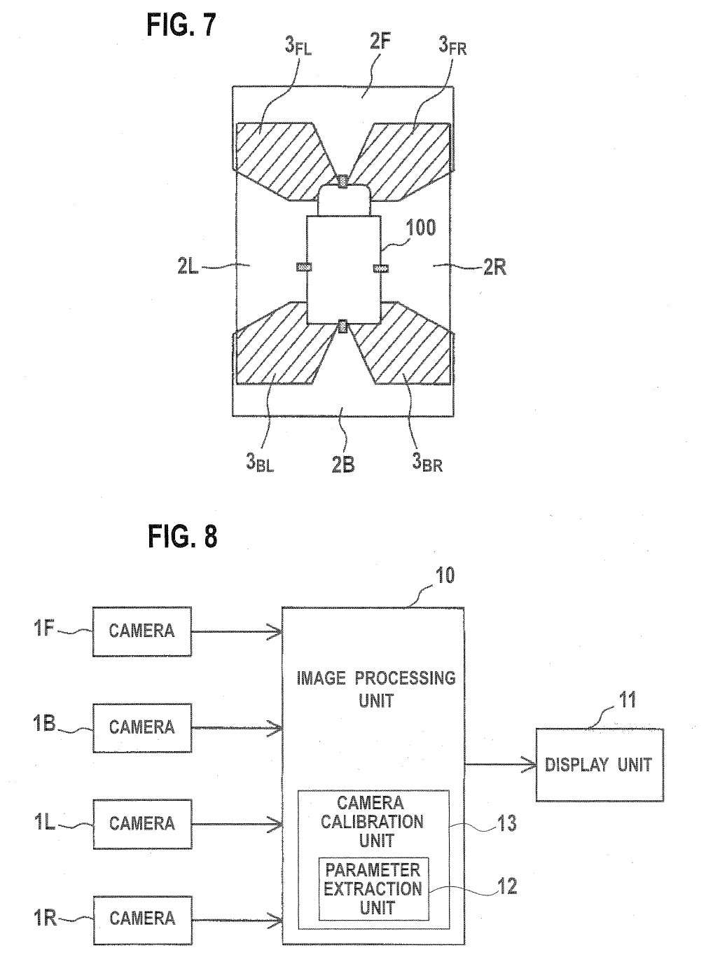

FIG. 6A to 6D shows the fields of view 2F, 2R, 2L, and 2B viewed from above, in other words, the fields of view 2F, 2R, 2L, and 2B on the ground. FIG. 7 shows a schematic view in which all of the fields of view as shown in FIG. 6 are put together. The shaded area in FIG. 7 will be described below.

The camera 1F captures an image of a subject (including the road surface) located within a predetermined region in front of the vehicle 100. The camera 1R captures an image of a subject positioned within a predetermined region at the right side of the vehicle 100. The camera 1L captures an image of a subject positioned within a predetermined region at the left side of the vehicle 100. The camera 1B captures an image of a subject positioned within a predetermined region behind the vehicle 100.

The fields of view 2F and 2L of the cameras 1F and 1L overlap at the predetermined region 3_{FL} at the obliquely left-forward of the vehicle 100. This region will be referred to as a common field of view. In FIG. 7, the common fields of view are shown as shaded areas. Similarly, as shown in FIG. 7, the fields of view 2F and 2R overlap at a common field of view 3_{FR} towards the obliquely right-forward of the vehicle 100; the fields of view 2B and 2L overlap at a common field of view 3_{BL} towards the obliquely left-backward of the vehicle 100; and the fields of view 2B and 2R overlap at a common field of view 3_{BR} towards the obliquely right-backward of the vehicle 100.

FIG. 8 shows a block diagram of a configuration of the visibility support system according to one embodiment of the invention. Each camera 1F, 1R, 1L, and 1B captures images, and signals that represent images obtained by the image-taking (also referred to as obtained images) are sent to an image processing unit 10. The image processing unit 10 converts each obtained image to a bird's eye view image by a viewpoint transformation, and generates one 360° bird's eye view image by synthesizing the bird's eye view images. A display unit 11 displays this 360° bird's eye view image as a video picture. It should be noted, however, that the captured images from which the bird's eye view images are generated are processed to correct artifacts such as lens distortions, and the captured images after being processed are converted to the bird's eye view images.

The bird's eye view image is an image obtained by converting a captured image from an actual camera (such as the camera 1F) to an image viewed from an observing point of a virtual camera (virtual observing point). More specifically, the bird's eye view image is an image obtained by converting an actual camera image to an image from a virtual camera looking toward the ground in the vertical direction. In general, this type of image transformation also is called a viewpoint transformation. By displaying the 360° bird's eye view image corresponding to a synthesized image of such bird's eye view images, a driver's field of view is enhanced, making it easy for the driver to confirm safe conditions surrounding the vehicle.

For example, cameras using CCD (Charge Coupled Devices) or CMOS (Complementary Metal Oxide Semiconductor) image sensors may be used as the cameras IF, 1R, 1L, and 1B. The image processing device 10 for example is an integrated circuit. The display unit 11 is a liquid crystal display panel. A display device included in a car navigation system also can be used as the display unit 11 of the visibility support system. Also, the image processing unit 10 may be incorporated as a part of the car navigation system. The image processing unit 10 and the display unit 11 are mounted for example in the vicinity of the driver's seat of the vehicle 100.

A view field angle of each camera is made wide-angled to support safety confirmation covering a wide field. Therefore, the field of view of each camera has a size of for example 5 m×10 m on the ground.

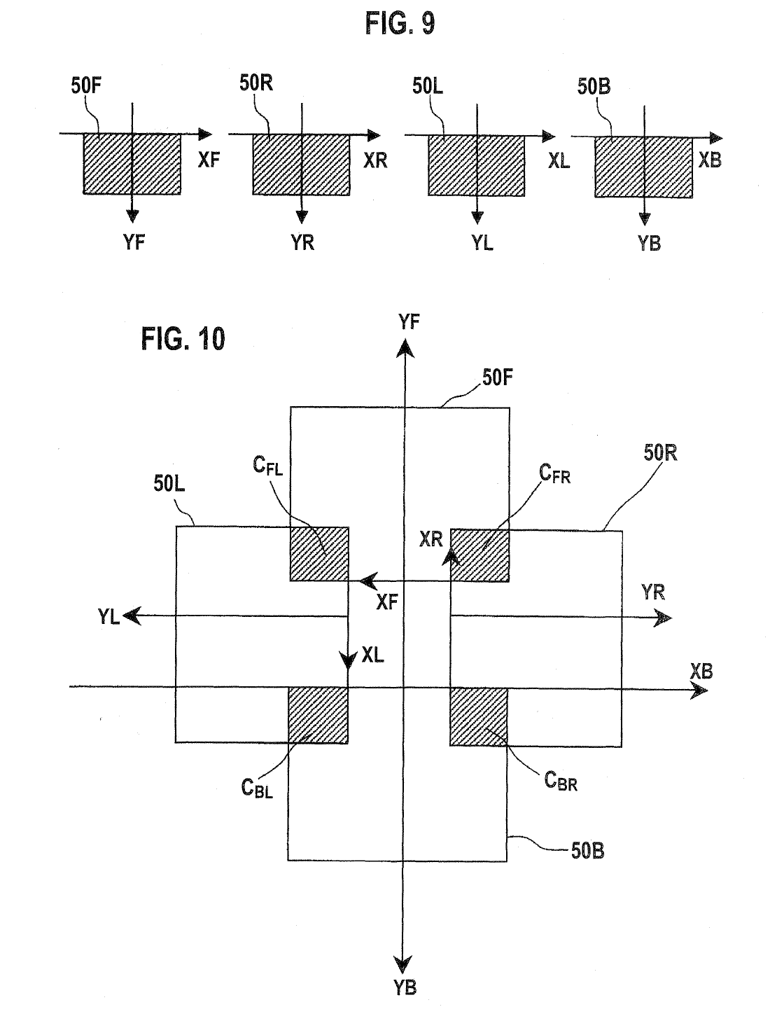

In this embodiment, the image captured by each camera is converted to a bird's eye view image by the perspective projection transformation or the planar projective transformation. The perspective projection transformation and the planar projective transformation are known and will be described below. FIG. 9 shows bird's eye view images 50F, 50R, 50L, and 50B that are generated from the images captured by the cameras 1F, 1R, 1L, and 1B. After the conversion to the bird's eye view images, three bird's eye view images 50F, 50R, and 50B are converted into the bird's eye view image coordinate system of the bird's eye view image 50L by the rotation and/or parallel translation with respect to the bird's eye view image SOL for the camera 1L. As such, the coordinates of each bird's eye view image is converted to that of the 360° bird's eye view image. Coordinates on the 360° bird's eye view image will be referred to as “global coordinates” below. The global coordinate system is a two-dimensional coordinate system commonly defined for all the cameras.

FIG. 10 shows the bird's eye view images 50F, 50R, 50L, and 50B reflected on the global coordinate system. On the global coordinate system, as shown in FIG. 10, there exists an overlapping part between two bird's eye view images.

In FIG. 10, a shaded region to which a reference symbol C_{FL} is assigned is the overlapping part between the bird's eye view images 50F and 50L, which will be referred to as a common image region C_{FL}. In the bird's eye view image 50F, a subject within the common field of view 3_{FL} (see FIG. 7) viewed from the camera 1F appears in the common image region C_{FL}, and in the bird's eye view image 50L, the subject within the common field of view 3_{FL} viewed from the camera 1L appears in the common image region C_{FL}. Similarly, there are a common image region C_{FR} where the bird's eye view images 50F and 50R overlap, a common image region C_{BL} where the bird's eye view images 50B and 50L overlap, and a common image region C_{BR} where the bird's eye view images 50B and 50R overlap.

When generating the 360° bird's eye view image by image synthesizing, the images within the common field of view regions are generated by averaging pixel values between the synthesized images, or by pasting the images to be synthesized together at a defined borderline. In either way, image synthesizing is performed such that each bird's eye view image is joined smoothly at the interfaces.

In FIGS. 9 and 10, the XF axis and the YF axis are coordinate axes of the coordinate system of the bird's eye view image 50F. Similarly, the XR axis and the YR axis are coordinate axes of the coordinate system of the bird's eye view image 50R; the XL axis and the YL axis are coordinate axes of the coordinate system of the bird's eye view image 50L; and the XB axis and the YB axis are coordinate axes of the coordinate system of the bird's eye view image 50B. Although each of the bird's eye view images and the common image regions has a rectangular shape in FIGS. 9 and 10, the shape is not limited to rectangles.

In order to generate the 360° bird's eye view image (or each bird's eye view image), transformation parameters for generating the 360° bird's eye view image (or each bird's eye view image) from each captured image are necessary. By such transformation parameters, a corresponding relation between coordinates of each point on each of the captured images and coordinates of each point on the 360° bird's eye view image is specified. The image processing unit 10 calibrates the transformation parameters in a calibration processing which is performed before an actual operation. At the time of the actual operation, the 360° bird's eye view image is generated from each captured image as described above, using the calibrated transformation parameters. This embodiment has its features in this calibration processing.

Before describing this calibration processing, the planar projective transformation will be explained briefly. An instance of converting an original image to a converted image by the planar projective transformation will be considered. Coordinates of each point on the original image are represented by (x, y) and coordinates of each point on the converted image are represented by (X, Y). The relation between the coordinates (x, y) on the original image and the coordinates (X, Y) on the converted image is expressed by the following formula (1) using a homography matrix H. The homography matrix H is a 3×3 matrix and each of the elements of the matrix is expressed by h₁ to h₉. Moreover, h₉=1 (the matrix is normalized such that h₉=1). From the formula (1), the relation between the coordinates (x, y) and the coordinates (X, Y) also can be expressed by the following formulas (2a) and (2b).

$$\begin{matrix}\begin{matrix}( \begin{matrix}X \\ Y \\ 1\end{matrix} ) = H ( \begin{matrix}x \\ y \\ 1\end{matrix} ) \\ = ( \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ) ( \begin{matrix}x \\ y \\ 1\end{matrix} ) \\ = ( \begin{matrix}{h}_{1} & {h}_{2} & {h}_{3} \\ {h}_{4} & {h}_{5} & {h}_{6} \\ {h}_{7} & {h}_{8} & 1\end{matrix} ) ( \begin{matrix}x \\ y \\ 1\end{matrix} )\end{matrix} & ( 1 ) \\ X = \frac{{h}_{1} x + {h}_{2} y + {h}_{3}}{{h}_{7} x + {h}_{8} y + {h}_{9}} & ( 2 a ) \\ Y = \frac{{h}_{4} x + {h}_{5} y + {h}_{6}}{{h}_{7} x + {h}_{8} y + {h}_{9}} & ( 2 b )\end{matrix}$$

The homography matrix H is uniquely determined if corresponding relations of the coordinates of four points between the original image and the converted image are known. Once the homography matrix H is obtained, it becomes possible to convert a given point on the original image to a point on the converted image according to the above formulas (2a) and (2b).

Next, referring to FIG. 11, a calibration processing procedure according to this embodiment will be described. FIG. 11 is a flowchart indicating this procedure. This calibration processing includes step S11 and step S12, which are implemented by each camera and the image processing unit 10. In this procedure, transformation parameters to be obtained are divided to a first parameter for the cameras 1R and 1L as reference cameras, and a second parameter for the cameras 1F and 1B as non-reference cameras.

First, at step S11, transformation parameters for the cameras 1R and 1L (i.e. the first parameter) are computed based on the perspective projection transformation.

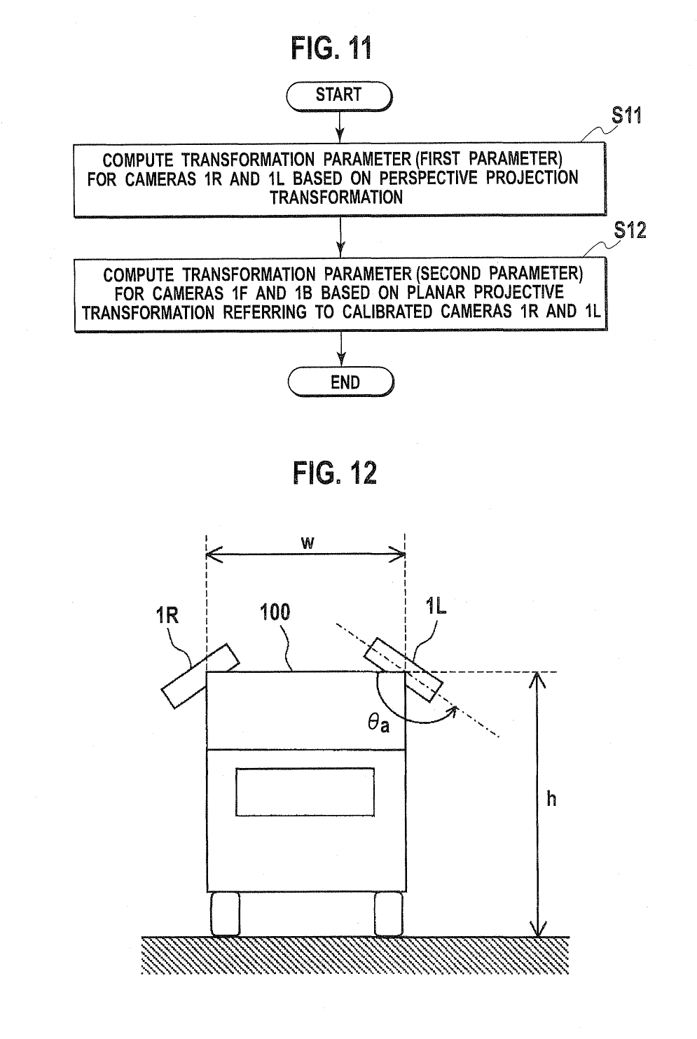

A technique to convert an image captured by one camera to a bird's eye view image by the perspective projection transformation will be explained briefly. When indicating coordinates of each point on the captured image as (x_{bu}, y_{bu}) and indicating coordinates of each point on the bird's eye view image as (xₐᵤ, yₐᵤ), a formula to convert the coordinates (x_{bu}, y_{bu}) to the coordinates (xₐᵤ, yₐᵤ) is expressed by the following formula (3).

$$[ \begin{matrix}{x}_{a u} \\ {y}_{a u}\end{matrix} ] = [ \begin{matrix}\frac{{x}_{bu} ( fh sin {θ}_{a} + {H}_{a} {y}_{a u} cos {θ}_{a} )}{{fH}_{a}} \\ \frac{fh ( f cos {θ}_{a} - {y}_{bu} sin {θ}_{a} )}{{h}_{a} ( f sin {θ}_{a} + {y}_{bu} cos {θ}_{a} )}\end{matrix} ] \qquad ( 3 )$$

Where θₐ is an angle between the ground and the optical axis of the camera (in this regard, however, 90°<θₐ<180°) as shown in FIG. 12. In FIG. 12, the camera 1L is shown as an example of the camera having the mounting angle of θₐ; h is an amount based on the height of the camera (the amount of parallel translations in the height direction in the camera coordinate system and the world coordinate system); f is a focal distance of the camera. As described above, the bird's eye view image is an image obtained by converting a captured image of an actual camera to an image viewed from an observing point of a virtual camera (virtual observing point), and Ha indicates a height of this virtual camera.

The θₐ, h, and Hₐ can be perceived as camera external information (camera external parameters), while f can be perceived as camera internal information (camera internal parameters). By the coordinate transformation of each point in the captured image by the camera using the formula (3) based on such information, the bird's eye view image can be generated.

In FIG. 12, w indicates a width of the vehicle 100. Because a distance between the cameras 1L and 1R (such as a distance between an imaging area of the camera 1L and an imaging area of the camera 1R) depends on the width w of the vehicle 100, this width w also can be perceived as a distance between the camera 1L and the camera 1R.

The image processing unit 10 already has the information of θₐ, h, f, and Hₐ that are necessary for the perspective projection transformation respectively for the cameras 1R and 1L, and by the coordinate transformation of each point in each captured image by the cameras 1R and 1L based on the formula (3), each bird's eye view image for the cameras 1R and 1L can be generated.

Furthermore, the image processing unit 10 also has the information of the width w of the vehicle 100 in advance. The width w and the θₐ, h, f, and Hₐ respectively for the cameras 1R and 1L, collectively will be referred to as camera setup information. The amount of rotation and/or the amount of parallel translation are determined based on the camera setup information for the coordinate transformation of the bird's eye view image 50R from the captured image by the camera 1R to the global coordinate system.

At step S11, therefore, based on the above formula (3) and the camera setup information, transformation parameters for the coordinate transformation of each point on each of the images captured by the cameras 1R and 1L to the global coordinate system, in other words, transformation parameters (the first parameters) for the cameras 1R and 1L are obtained.

After step S11, the procedure moves to step S12 (see FIG. 11). At step S12, markers having feature points are located at the common fields of view 3_{FR} and 3_{FL} of the camera 1F and the cameras 1R and 1L, and the common fields of view 3_{BR} and 3_{BL} of the camera 1B and the cameras 1R and 1L. Then, using captured results of each marker (feature point) by each camera, transformation parameters (i.e. the second parameters) is computed for the cameras 1F and 1K by the planar projective transformation. At this time, the cameras 1R and 1L that were already calibrated at step S11 are used as references.

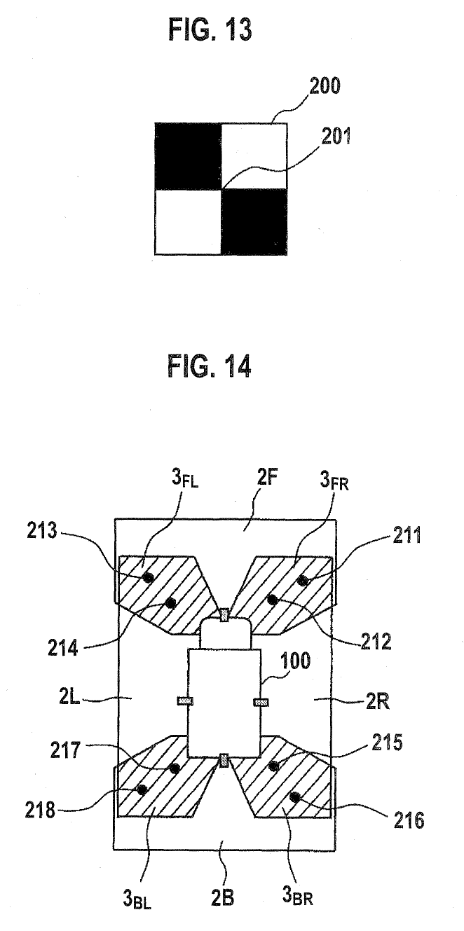

In FIG. 13, a marker 200 is shown as an example of the marker. FIG. 13 is a plan view of the marker 200 viewed from above. In the marker 200, two black squares interlocked with one another at one vertex are painted in a white background, in which the connected portion 201 of the two black squares is the feature point. By selecting for example a color of the marker, each camera (and the image processing unit 10) can specifically distinguish and recognize the feature point against for example the road surface. What is important for the calibration processing is not the marker itself but the feature point, and as such, the explanation will be made by focusing on the feature point below.

FIG. 14 is a top plan view of the periphery of the vehicle 100 showing an arrangement of each marker (feature point). In FIG. 14, the points referred to as the reference numbers 211 to 218 represent feature points on the markers. In the example of FIG. 14, two markers are arranged at each of the common fields of view. This makes two feature points 211 and 212 being shown within the common field of view 3_{FR}, two feature points 213 and 214 being shown within the common field of view 3_{FL}, two feature points 215 and 216 being shown within the common field of view 3_{BR}, and two feature points 217 and 218 being shown within the common field of view 3_{BL}. In this state, each camera captures and obtains images. Each of the captured images obtained in this state will be referred to as captured images for calibration.

The image processing unit 10 detects coordinate values of each feature point on the captured images for calibration from each camera. The manner in which to detect the coordinate values is arbitrary. For example, coordinate values of each feature point may be detected automatically through image processing such as an edge detection process, or may be detected based on operations with respect to an operating unit which is not shown.

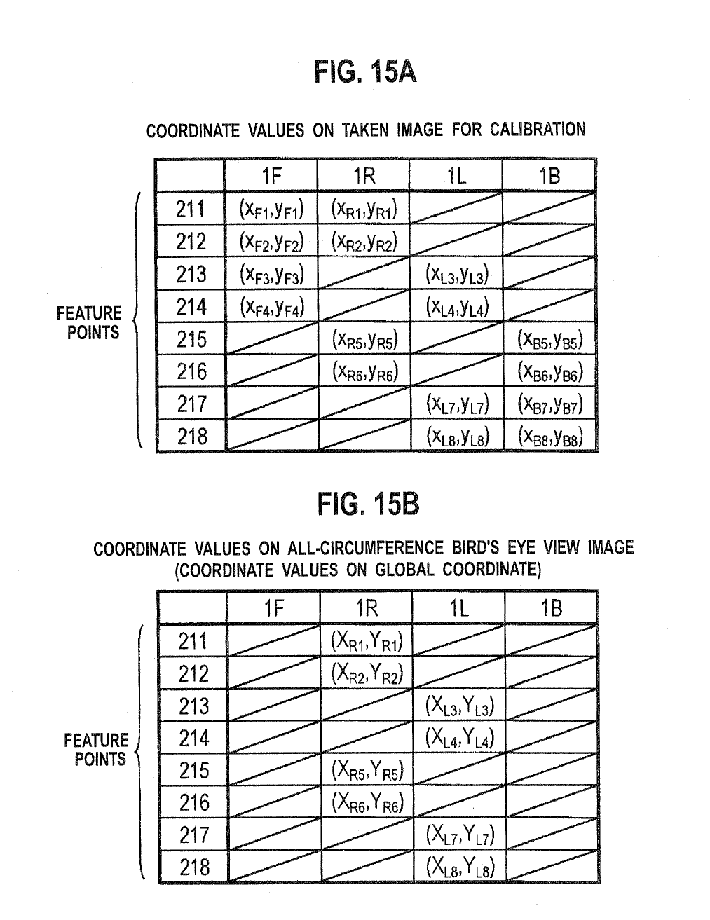

As shown in the table of FIG. 15A, it is regarded that coordinate values of the feature points 211, 212, 213, and 214 on the captured image for calibration of the camera 1F are respectively (x_{F1}, y_{F1}), (x_{F2}, y_{F2}), x_{F3}, y_{F3}), and (x_{F4}, y_{F4}); coordinate values of the feature points 211, 212, 215, and 216 on the captured image for calibration of the camera 1R are respectively (x_{R1}, y_{R1}), (x_{R2}, y_{R2}), (x_{R5}, y_{R5}), and (x_{R6}, y_{R6}); coordinate values of the feature points 213, 214, 217, and 218 on the captured image for calibration of the camera 1L are respectively (x_{L3}, y_{L3}), (x_{L4}, y_{L4}), (x_{L7}, y_{L7}), and (x_{L8}, y_{L8}); and coordinate values of the feature points 215, 216, 217, and 218 on the captured image for calibration of the camera 1B are respectively (x_{B5}, y_{B5}), (x_{B6}, y_{B6}), (x_{B7}, y_{B7}), and (x_{B8}, y_{B8}).

Furthermore, the coordinate values of the feature points 211, 212, 215, and 216 on the captured image for calibration of the camera 1R are converted to coordinate values on the global coordinate system using the first parameter obtained in step S11. The coordinate values of the feature points 211, 212, 215, and 216 on the global coordinate system obtained by this transformation are represented by (X_{R1}, Y_{R1}), (X_{R2}, Y_{R2}), (X_{R5}, Y_{R5}), and (X_{R6}, Y_{R6}) respectively, as shown in FIG. 15B. Similarly, the coordinate values of the feature points 213, 214, 217, and 218 on the captured image for calibration of the camera 1L are converted to coordinate values on the global coordinate system using the first parameters obtained in step S11. The coordinate values of the feature points 213, 214, 217, and 218 on the global coordinate system obtained by this transformation are represented by (X_{L3}, Y_{L3}), (X_{L4}, Y_{L4}), (X_{L7}, Y_{L7}), and (X_{L8}, Y_{L8}) respectively, as shown in FIG. 15B.

As described above, the homography matrix for performing the planar projective transformation is uniquely determined if corresponding relations of the coordinates of four points between the image before the transformation (the original image) and the image after the transformation (the converted image) are known. Because what is to be generated ultimately is a 360° bird's eye view image that corresponds to an synthesized image of each bird's eye view image, the homography matrix for the coordinate transformation of each of the captured images for calibration of the cameras 1F and 1B to the global coordinate system i.e. the coordinate system of the 360° bird's eye view image is obtained in this embodiment. At this time, locations of the feature points of the cameras 1R and 1L which were calibrated initially are used as reference bases.

A known technique may be used to obtain the homography matrix (projective transformation matrix) based on the corresponding relations of the coordinate values of four points between the image before the transformation (the original image) and the image after the transformation (the converted image). For example, a technique described in the above Japanese Laid-Open No. 2004-342067 (see especially the technique described in paragraph Nos. [0059] to [0069]) can be used.

When calibration is performed for the camera 1F, corresponding relations of the coordinate values of the four feature points 211 to 214 between the image before the transformation and the image after the transformation are used. In other words, the elements h₁ to h₈ of the homography matrix H for the camera 1F are obtained such that the coordinate values (x_{F1}, y_{F1}), (x_{F2}, y_{F2}), (x_{F3}, y_{F3}), and (x_{F4}, y_{F4}) of the image before the transformation are converted to the coordinate values (X_{R1}, Y_{R1}), (X_{R2}, Y_{R2}), (X_{L3}, Y_{L3}), and (X_{L4}, Y_{L4}) of the image after the transformation. In practice, the elements h₁ to h₈ are obtained such that errors of this transformation (the set valuation function described in Japanese Laid-Open No. 2004-342067) are minimized. The homography matrix obtained for the camera 1F is expressed by H_{F}. By using the homography matrix H_{F}, any arbitrary point on the captured image of the camera 1F can be converted to a point on the global coordinate system.

Similarly, when calibration is performed for the camera 1B, corresponding relations of the coordinate values of the four feature points 215 to 218 between the image before the transformation and the image after the transformation are used. In other words, the elements h₁ to h₈ of the homography matrix H for the camera 1F are obtained such that the coordinate values (x_{B5}, y_{B5}), (x_{B6}, y_{B6}), (x_{B7}, y_{B7}), and (x_{B8}, y_{B8}) of the image before the transformation are converted to the coordinate values (X_{R5}, Y_{R5}), (X_{R6}, Y_{R6}), (X_{L7}, Y_{L7}), and (X_{L8}, Y_{L8}) of the image after the transformation. In practice, the elements h₁ to h₈ are obtained such that errors of this transformation (the set valuation function described in Japanese Laid-Open No. 2004-342067) are minimized. The homography matrix obtained for the camera 1B is expressed by H_{B}. By using the homography matrix H_{B}, any arbitrary point on the captured image of the camera 1B can be converted to a point on the global coordinate system.

At step S12, the homography matrixes H_{F}and H_{B} are obtained as transformation parameters (i.e. the second parameters) for the cameras 1F and 1B. The calibration processing of FIG. 11 ends when the process of step S12 is finished.

In practice, first table data that indicate the corresponding relations between each coordinates on the captured images of the cameras 1R and 1L, and each coordinates on the 360° bird's eye view image (the global coordinate system) are prepared based on the above formula (3) and the camera setup information, and stored in a memory (lookup table) that is not shown. Similarly, second table data that indicate the corresponding relations between each coordinates on the captured images of the cameras 1F and 1B, and each coordinates on the 360° bird's eye view image (the global coordinate system) are prepared based on the homography matrixes H_{F}and H_{B}, and stored in a memory (lookup table) that is not shown. By using these table data, the 360° bird's eye view image can be generated from each captured image because any arbitrary point on each captured image can be converted to a point on the global coordinate system. In this case, the first table data can be perceived as transformation parameters for the cameras 1R and 1L (i.e. the first parameters) and the second table data can be perceived as transformation parameters for the cameras 1F and 1B (i.e. the second parameters).

When the image processing unit 10 utilizes such table data, at the time of an actual operation, each point on each captured image is transformed to each point on the 360° bird's eye view image at once, and therefore, individual bird's eye view images do not need to be generated.

After the calibration processing of FIG. 11, the image processing unit 10 converts each captured image continuously obtained at each camera to the 360° bird's eye view image using the obtained transformation parameters continuously. The image processing unit 10 supplies image signals that represent each 360° bird's eye view image to the display unit 11. The display unit 11 displays each 360° bird's eye view image as a moving image.

While two feature points (markers) are arranged at each common field of view in the above example, transformation parameters for the cameras 1F and 1B can be extracted as long as the total of at least four feature points are located within the common fields of view 3_{FR} and 3_{FL}, and the total of at least four feature points are located within the common fields of view 3_{BR} and 3_{BL}. At this time, it is also possible to locate the feature points only at one of the common fields of view 3_{FR} and 3_{FL}. However, in order to obtain a good synthesized image without distortion, it is desirable to distribute the feature points at both of the common fields of view 3_{FR} and 3_{FL}. The same applies to the common fields of view 3_{BR} and 3_{BL}. Also, relative positioning among the at least four feature points arranged in the common fields of view 3_{FR} and 3_{FL} can be selected arbitrarily. In the case of FIG. 14, for example, arranging positions of each feature point 211 to 214 can be determined completely freely and independently with each other. As such, as long as the feature points 211 to 214 are located within the common fields of view 3_{FR} and 3_{FL}, there is no restriction in the positioning of each feature point. The same applies to the feature points arranged in the common fields of view 3_{BR} and 3_{BL}.

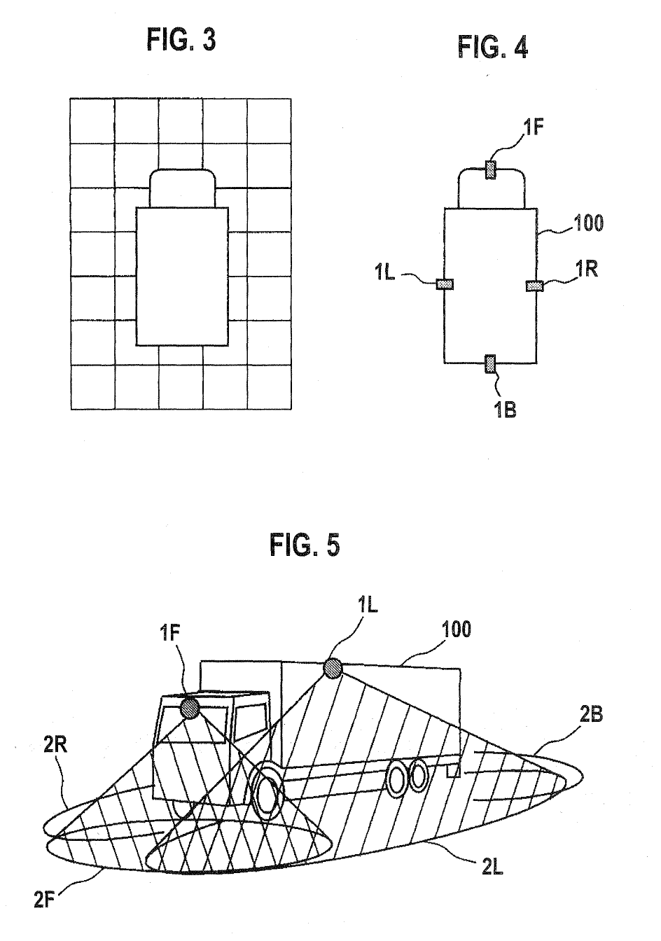

According to the calibration processing technique of this embodiment, a large calibration plate such as shown in FIG. 3 does not need to be prepared, and a calibration environment can be created by freely arranging the feature points within the common fields of view. Therefore, the calibration environment can be easily and conveniently created and a burden for the calibration operation can be alleviated.

Moreover, while calibration processing may be easy and convenient when all cameras are calibrated by only using the perspective projection transformation, distortion at the junctions of the synthesized images is created by the influence of camera installation errors. With the cameras 1F and 1R, for example, the image within the common field of view 3_{FR} captured by the camera 1F, and the image within the common field of view 3_{FR} captured by the camera 1R form different images on the global coordinate system which stem from installation errors of each camera. As a result, the image may become discontinuous or double image may appear at the junction in the 360° bird's eye view image.

Taking this into consideration, this embodiment performs the calibration processing by calibrating a part of the cameras by the perspective projection transformation, and then calibrating the rest of the cameras by the planar projective transformation so as to merge the calibration results of the part of the cameras into calibration of the rest of the cameras. As such, while the transformation parameter for the part of the cameras (such as the camera 1R) may be affected by camera setup errors, this influence can be absorbed by the transformation parameters for the rest of the cameras (such as the camera 1F). For example, after calibration processes for all the cameras are completed, the projected points of the feature point 211 of FIG. 14 captured by the cameras 1F and 1R on the global coordinate coincide completely (i.e. no double image is created). Therefore, according to this embodiment, the influence of the camera setup errors can be reduced and a synthesized image (360° bird's eye view image) without distortion at the junctions can be obtained.

### Second Embodiment

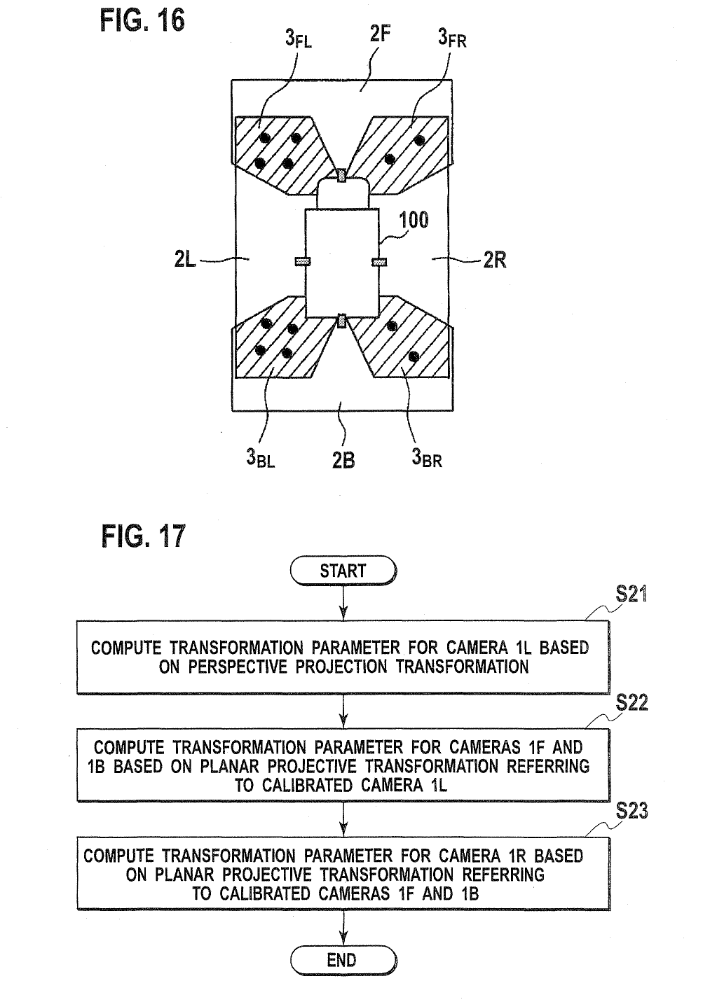

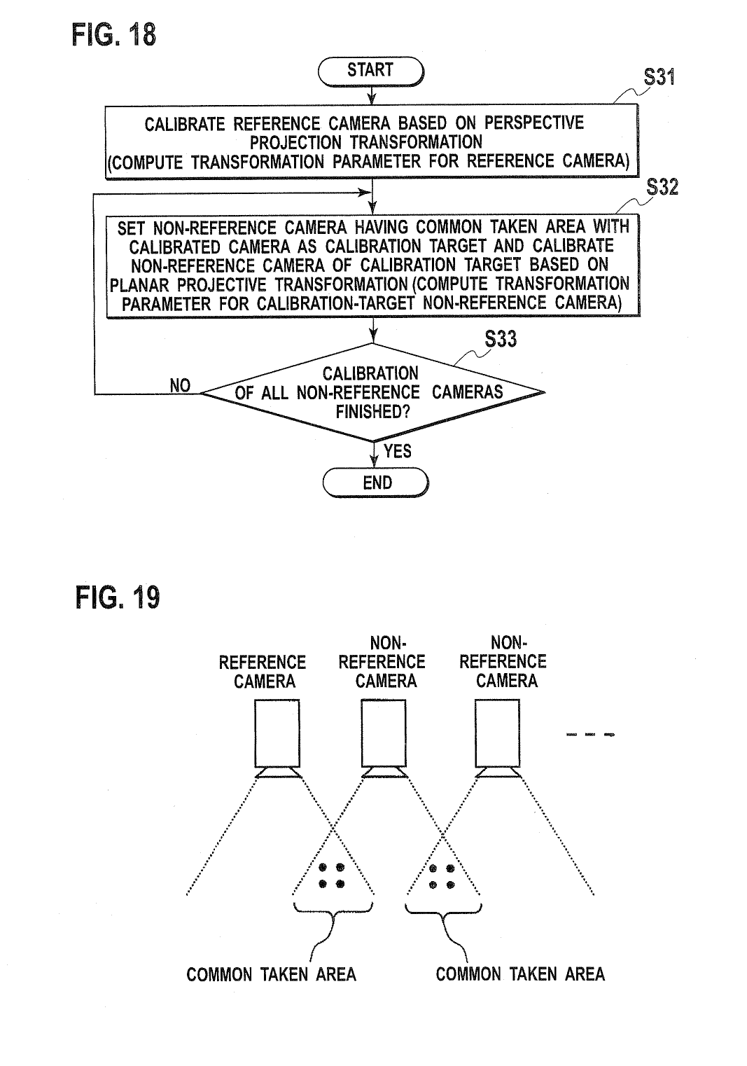

Moreover, by arranging the feature points as shown in FIG. 16, it is possible to perform the calibration processing as shown in FIG. 17. The embodiment of this processing will now be described as a second embodiment. The second embodiment corresponds to a variant of the first embodiment in which a part of the calibration processing method of the first embodiment is changed, and the content described in the first embodiment applies to the second embodiment as long as it is not contradictory. The calibration processing procedure that is different from the first embodiment will be explained below.

FIG. 17 is a flowchart showing a calibration processing procedure according to the second embodiment. First, at step S21, transformation parameters for the camera 1L as a reference camera is computed based on the perspective projection transformation. This computing method is the same as that of step S11 of FIG. 11.

Next, at step S22, four feature points (or more than four feature points) are placed at each of the common fields of view 3_{FL} and 3_{BL} as shown in FIG. 16. Then using the captured results of each of the feature points by the cameras 1F, 1L, and 1B, transformation parameters for the cameras 1F and 1B are computed by the planar projective transformation. At this time, the computation is made based on the camera 1L that already was calibrated at step S21.

The homography matrix (i.e. transformation parameters for the camera 1F) for the coordinate transformation of each point on the captured image of the camera 1F to each point on the global coordinate system can be computed by taking images of the at least four feature points that are common between the cameras 1L and 1F and by identifying coordinate values of each of the feature points in a condition that transformation parameters for the camera 1L are known, in a similar way as described in the first embodiment. The same applies to the camera 1B.

Next, at step S23, two feature points respectively at each of the common fields of view 3_{FR} and 3_{BR} (or the total of at least four feature points) are located. Then, transformation parameters for the camera 1R are computed by the planar projective transformation using the captured results of each feature points by the cameras 1F, 1R, and 1B.

The homography matrix (i.e. transformation parameters for the camera 1R) can be computed for the coordinate transformation of each point on the captured image of the camera 1R to each point on the global coordinate system, by having images of at least four feature points captured by the cameras 1F and 1B and the camera 1R, and by identifying coordinate values of each of the feature points in a similar way as described in the first embodiment in a condition that transformation parameters for the cameras 1F and 1B are known. Comparable processes are possible by placing the at least four feature points only in one of the common fields of view 3_{FR} and 3_{BR}.

Similarly to the first embodiment, each of the transformation parameters obtained at steps S21 to S23 can be represented as table data showing the corresponding relations of each coordinates on the captured images and each coordinates on the 360° bird's view image (the global coordinate system). By using this table data, it becomes possible to generate the 360° bird's eye view image from each captured image because an arbitrary point on each captured image can be converted to a point on the global coordinate system.

As can be understood from the fact that the first embodiment can be changed to the second embodiment, to describe in a more general way, the following calibration procedure can be taken. The plurality of cameras are divided into at least one reference camera and at least one non-reference camera. An example of such classification is shown in FIG. 19.

First at step S31, transformation parameters for the reference camera are obtained by the perspective projection transformation based on the camera setup information (i.e. the reference camera is calibrated).

Then at step S32, at least four feature points are arranged at the common field of view between the calibrated reference camera and the non-reference camera that is a calibration target. Then transformation parameters for the calibration-target non-reference camera are obtained by the planar projective transformation based on the corresponding relations of each feature point coordinates captured by the calibrated reference camera and by the calibration-target non-reference camera and the transformation parameters for the calibrated reference camera (i.e. the calibration-target non-reference camera is calibrated).

If there exists a non-reference camera that has not been calibrated yet (N of step S33), the above process of step S32 is repeated by referring to the reference camera or by setting the non-reference camera that was already calibrated as a reference camera (FIG. 19 shows an example of the latter). By the above processes, all cameras can be calibrated.

### Third Embodiment

Next, the third embodiment will be explained. The third embodiment corresponds to a variant of the first embodiment in which a part of the calibration method of the first embodiment is changed, and the content described in the first embodiment applies to the third embodiment as long as it is not contradictory. The calibration processing procedure that is different from the first embodiment will be explained below.

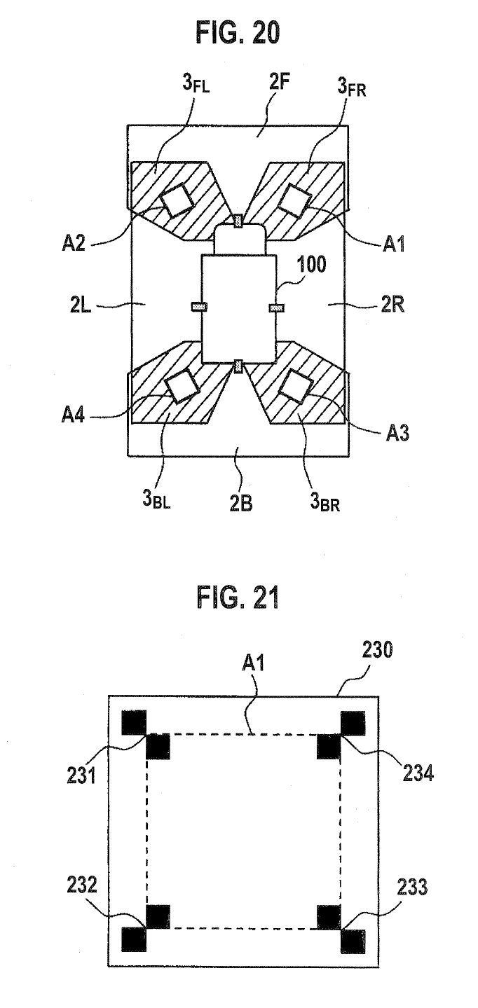

In the third embodiment, a calibration pattern is used at the time of the calibration processing. FIG. 20 is a plan view of the periphery of the vehicle 100 showing an arrangement of each calibration pattern. As shown in FIG. 20, planar (two-dimensional) calibration patterns A1, A2, A3, and A4 are arranged within each of the common fields of view 3_{FR}, 3_{FL}, 3_{BR}, and 3_{BL}. The calibration patterns A1 to A4 are located on the ground.

Each of the calibration patterns has a square configuration having the length of each side e.g. about 1 m to 1.5 m. While it is not necessary that all of the calibration patterns 1A to 4A have the same shape, it is regarded that they have the same shape for the convenience of explanation. The configuration here is a concept that also includes its size. Therefore, the calibration patterns 1A to 4A are identical. Each configuration of the calibration patterns ideally should be square in the bird's eye view image (see FIG. 24).

Since each calibration pattern has a square configuration, it has four feature points. In this example, the four feature points correspond to four vertices that form the square. The image processing unit 10 already has information on the shape of each calibration pattern as known information. Due to this known information, relative positional relations among the four feature points of an ideal calibration pattern (A1, A2, A3 or A4) on the 360° bird's eye view image or on the bird's eye view image are being specified.

The shape of the calibration pattern means a shape of the figure formed by connecting the feature points in its calibration pattern. For example, the four calibration plates having the square shape by itself may be regarded as the four calibration patterns A1 to A4, and their four corners may be treated as the four feature points. Alternatively, a calibration plate on which the calibration pattern Al is drawn; a calibration plate on which the calibration pattern A2 is drawn; a calibration plate on which the calibration pattern A3 is drawn; and a calibration plate on which the calibration pattern A4 is drawn may be prepared. In this case, the contours of the calibration plates themselves do not correspond to the contours of the calibration patterns. As an example, FIG. 21 shows a plan view of a square calibration plate 230 on which the calibration pattern Al is drawn. The calibration pattern 230 has a white background with two black squares connected with each other at one vertex drawn at each corner of the calibration plate 230. The joints 231 to 234 of the two black squares at the four corners of the calibration plate 230 correspond to the feature points of the calibration pattern A1.

By appropriately selecting the color of the calibration plate itself or the color of the marking drawn on the calibration plate, each camera (and the image processing unit 10) can clearly distinguish and recognize each feature point of the calibration pattern from the road surface. Because it is the shape of the calibration pattern (i.e. positional relations among the feature points) and not the calibration plate itself that is important for the calibration process, the following explanation will be made by ignoring the existence of the calibration plate and focusing on the calibration pattern.

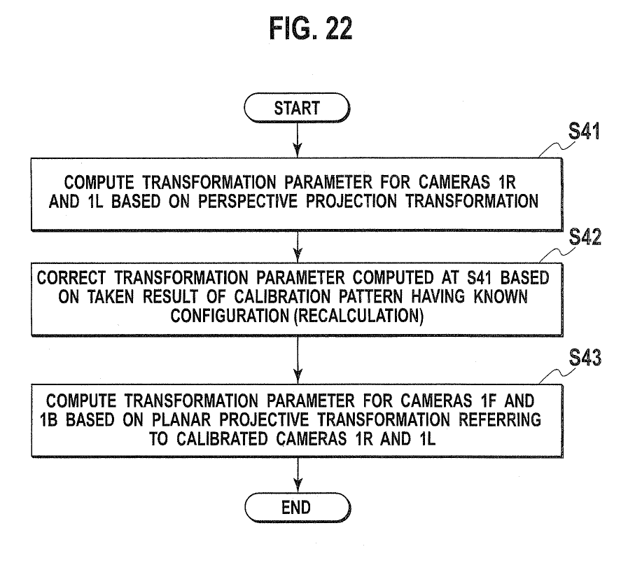

Now referring to FIG. 22, a calibration processing procedure according to the third embodiment will be explained. FIG. 22 is a flowchart indicating this procedure.

First, at step S41, transformation parameters for the cameras 1R and 1L as reference cameras are computed based on the perspective projection transformation. The process of this step S41 is the same as that of step S11 of the first embodiment (FIG. 11).

Next, at step S42, in a condition that the calibration patterns Al to A4 are located within each of the common fields of view as shown in FIG. 20, the cameras 1R and 1L take the images. The captured images thereby obtained will be referred to as “captured images for correction.” Then, each of the captured images for correction captured by the cameras 1R and 1L is converted to a bird's eye view image using the transformation parameters obtained by step S41 (which will be referred to as a “bird's eye view image for correction”).

Because the calibration pattern has a known square shape, ideally each calibration pattern on each of the bird's eye view image for correction has the known square configuration. However, there may be errors at the time of installation of the cameras 1R and 1L. For example, there exists an error between the actual installation angle of the camera 1L and the designed value of θₐ set in the camera setup information. Due to such installation errors, each calibration pattern usually does not have the known square configuration on the each bird's eye view image for correction.

Given this factor, the image processing unit 10 searches for the value θₐ that makes the shape of each calibration pattern on the bird's eye view image for correction to come close to the known square configuration based on the known information, and estimates the errors regarding the installation angles. Then transformation parameters for the cameras 1R and 1L are newly recalculated based on the searched value of θₐ.

More specifically, for example, this can be done by computing an error assessment value D that indicates errors between the shape of the actual calibration pattern on the bird's eye view image for correction and the shape of the ideal calibration pattern respectively for the cameras 1R and 1L, and searching for the value of θₐ that gives the minimum value to the error assessment value D.

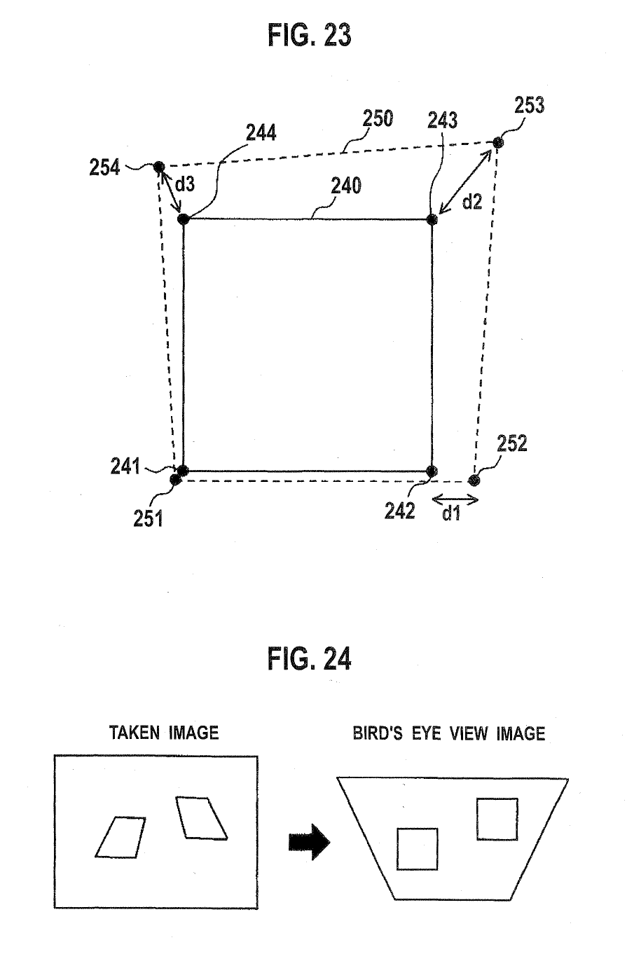

Referring to FIG. 23, a computing method for the error assessment value D for the camera 1L will be explained. In FIG. 23, square 240 indicates the shape of an ideal calibration pattern (A2 or A4) on the bird's eye view image for correction. On the other hand, quadrangle 250 indicates the shape of an actual calibration pattern (A2 or A4) on the bird's eye view image for correction. As described above, the shape of the square 240 is known by the image processing unit 10.

In FIG. 23, reference numbers 241 to 244 indicate four vertices of the square 240, while reference numbers 251 to 254 indicate four vertices of the quadrangle 250. On the bird's eye view image for correction, coordinates of the vertex 241 and that of the vertex 251 are being coincided, while the line segment that connects the vertex 241 and the vertex 242, and the line segment that connects the vertex 251 and the vertex 252 are being superimposed. In FIG. 23, however, the square 240 and the quadrangle 250 are shown slightly displaced with each other for illustrative convenience.

In this instance, the position error between the vertex 242 and the vertex 252 is referred to as d1; the position error between the vertex 243 and the vertex 253 is referred to as d2; and the position error between the vertex 244 and the vertex 254 is referred to as d3. The position error d1 is a distance between the vertex 242 and the vertex 252 on the bird's eye view image for correction. The same applies to the position errors d2 and d3.

Such position errors d1 to d3 are computed respectively for the calibration patterns A2 and A4 captured by the camera 1L. Therefore, six position errors are computed for the bird's eye view image for correction of the camera 1L. The error assessment value D is a summation of these six position errors. Because the position error is a distance between the vertices being compared, the position error is always either zero or a positive value. A formula for computation of the error assessment value D is expressed by the following formula (4). In the right-hand side, Σ for the (d1+d2+d3) means that the summation contains a number of the calibration patterns.

$$D = \sum {\sum }_{n = 1}^{3} dn \qquad ( 4 )$$

The value of θₐ that gives the minimum value to the error assessment value D is obtained by successively computing the error assessment value D by varying the value of θₐ in the above formula (3). Then, the value of θₐ that was initially set for the camera 1L in the camera setup information is corrected to the corrected value of θₐ, and transformation parameters for the camera 1L are newly recalculated using the corrected value of θₐ (i.e. the value of θₐ that gives the minimum value to the error assessment value D). The same processing is performed for the camera 1R as well, and transformation parameters for the camera 1R are recalculated.

After recalculating the transformation parameters for the cameras 1R and 1L at step S42, the process moves to step S43. At step S43, each camera is made to take images in a condition that the calibration patterns A1 to A4 are located within each common field of view as shown in FIG. 20, and the transformation parameters (homography matrixes) for the cameras 1F and 1B are computed by the planar projective transformation using the captured results of each calibration pattern (feature point) by each camera. At this time, the computation is made based on the cameras 1R and 1L that were calibrated at step S42.

The content of the process of step S43 is the same as that of step S12 (FIG. 11) of the first embodiment. However, transformation parameters for the cameras 1R and 1L recalculated at step S42 are used in this case. In obtaining the transformation parameters for the camera 1F, p number of feature points contained in the calibration pattern A1 and q number of feature points contained in the calibration pattern A2 may be used. Alternatively, only the four feature points contained in either one of the calibration patterns A1 and A2 may be used. Here, p and q are integer numbers and 1≦p≦4, 1≦q≦4, and p+q≧4. The same applies when obtaining transformation parameters for the camera 1B.

Similarly to the first embodiment, each of the transformation parameters obtained at steps S42 and S43 can be represented as table data showing the corresponding relations of each coordinates on the captured images and each coordinates on the 360° bird's view image (the global coordinate system). By using this table data, it becomes possible to generate the 360° bird's eye view image from each captured image because an arbitrary point on each captured image can be converted to a point on the global coordinate system.

In the example described above, each calibration pattern is located within the common fields of view during step S42, since it is necessary to locate the calibration patterns within the common fields of view at the process of step S43. However, it is not necessarily needed to locate each calibration pattern within the common fields of view at the stage of step S42. In other words, the process of step S42 can be performed by positioning at least one calibration pattern in the entire field of view (2R) of the camera 1R, and also positioning at least one calibration pattern in the entire field of view (2L) of the camera 1L.

Also, positioning of the calibration patterns within the common fields of view is free and relative positions between different calibration patterns also can be freely selected. Arranging positions of each calibration pattern can be independently determined with each other. As such, as long as the calibration pattern is located within the common field of view of the already calibrated reference camera (the cameras 1R and 1L in this embodiment) and the calibration-target non-reference camera (the cameras 1F and 1B in this embodiment), there is no restriction in the positioning of the calibration pattern.

Moreover, the shape of the calibration pattern does not have to be square. As long as at least four feature points are included in each calibration pattern, the configuration of each calibration pattern can be varied in many ways. It is necessary, however, that the image processing unit 10 knows its configuration in advance.

According to the third embodiment, camera setup errors can be corrected in addition to producing the similar effects obtained by the first embodiment, and therefore, calibration accuracy can be improved.

(Variants)

Variants of the above described embodiments as well as explanatory notes will be explained below. The contents described below can be arbitrarily combined as long as it is not contradictory.

The bird's eye view image described above corresponds to an image that a captured image of each camera is projected onto the ground. The plane onto which the captured images are projected may be an arbitrary predetermined plane other than the ground (e.g. a predetermined plane), even though the 360° bird's view image in the above embodiments was generated by projecting the captured images of each camera on the ground and synthesizing them.

While the explanation was made for the embodiments by giving an example of the visibility support system that uses the cameras 1F, 1R, 1L, and 1B as on-vehicle cameras, it is also possible to install each camera connected to the image processing unit 10 onto places other than the vehicle. That is, this invention is also applicable to a surveillance system such as in a building. In this type of the surveillance system also, each captured image from multiple cameras is projected on a predetermined plane and synthesized, and the synthesized image is displayed on a display device, similarly to the above-described embodiments.

The functions of the image processing unit 10 of FIG. 8 can be performed by hardware, software or a combination thereof. All or a part of the functions enabled by the image processing unit 10 may be written as a program and implemented on a computer.

A parameter extraction unit 12 that extracts transformation parameters at the time of the calibration processing may exist within the image processing unit 10, and a camera calibration unit 13 that performs the camera calibration processing with the parameter extraction unit 12 also may exist within the image processing unit 10. Also, the parameter extraction unit 12 may include a parameter correction unit for correcting transformation parameters for the cameras 1R and 1L. This parameter correction unit implements the process of step S42 of FIG. 22 in the third embodiment. The above marker and calibration pattern (or calibration plate) function as a calibration marker. However, the feature point itself may be treated as a calibration marker.

As described above, according to the present invention, it is possible to provide a camera calibration device and a camera calibration method that contribute to creating a simple and convenient calibration environment, while minimizing an influence of errors with respect to known setup information.

The invention may be embodied in other specific forms without departing from the spirit or essential characteristics thereof. The embodiments therefore are to be considered in all respects as illustrative and not restrictive; the scope of the invention being indicated by the appended claims rather than by the foregoing description, and all changes that come within the meaning and range of equivalency of the claims are therefore intended to be embraced therein.

What is claimed is:

1. A camera calibration device, comprising:
a parameter extraction unit that obtains parameters for projecting captured images from at least two cameras on a predetermined plane and synthesizing the captured images,
wherein the at least two cameras comprise at least one reference camera and at least one non-reference camera,
wherein the parameters comprise a first parameter for the reference camera obtained based on known setup information and a second parameter for the non-reference camera, and
wherein the parameter extraction unit obtains the second parameter based on the first parameter and captured results of a calibration marker by the reference camera and by the non-reference camera, the calibration marker being located within a common field of view of the reference camera and the non-reference camera.

2. The camera calibration device according to claim 1, wherein the first parameter is obtained based on a perspective projection transformation using the known setup information.

3. The camera calibration device according to claim 1,
wherein the calibration marker provides at least four feature points within the common field of view, and
wherein the parameter extraction unit obtains the second parameter based on a captured result of each of the feature points by the reference camera, a captured result of each of the feature points by the non-reference camera, and the first parameter.

4. The camera calibration device according to claim 4, wherein the second parameter is obtained by a planar projective transformation based on coordinate values of a captured result of each of the feature points by the non-reference camera, and coordinate values of a captured result of each of the feature points by the reference camera that have been converted using the first parameter.

5. The camera calibration device according to claim 1, wherein the parameter extraction unit extracts the second parameter without restricting an arranging position of the calibration marker within the common field of view.

6. The camera calibration device according to claim 1,
wherein the calibration marker is a calibration pattern having a known configuration,
wherein the parameter extraction unit includes a first parameter correction unit for correcting the first parameter based on a captured result of the calibration pattern having the known configuration by the reference camera, and
wherein the parameter extraction unit obtains the second parameter using the first parameter corrected by the first parameter correction unit.

7. The camera calibration device according to claim 6,
wherein the known calibration pattern has a square configuration and four vertices of the square configuration are utilized for calibration as four feature points.

8. A vehicle having at least two cameras and an image processing unit installed therein, comprising:
a parameter extraction unit contained in the image processing unit for obtaining parameters for projecting captured images from the at least two cameras on a predetermined plane and synthesizing the captured images,
wherein the at least two cameras comprise at least one reference camera and at least one non-reference camera,
wherein the parameters comprise a first parameter for the reference camera obtained based on known setup information and a second parameter for the non-reference camera, and
wherein the parameter extraction unit obtains the second parameter based on the first parameter and captured results of a calibration marker by the reference camera and by the non-reference camera, the calibration marker being located within a common field of view of the reference camera and the non-reference camera.

9. The vehicle according to claim 8, wherein the first parameter is obtained based on a perspective projection transformation using the known setup information.

10. The vehicle according to claim 8,
wherein the calibration marker provides at least four feature points within the common field of view, and
wherein the parameter extraction unit obtains the second parameter based on a captured result of each of the feature points by the reference camera, a captured result of each of the feature points by the non-reference camera, and the first parameter.

11. The vehicle according to claim 10, wherein the second parameter is obtained by a planar projective transformation based on coordinate values of a captured result of each of the feature points by the non-reference camera, and coordinate values of a captured result of each of the feature points by the reference camera that have been converted using the first parameter.

12. The vehicle according to claim 8, wherein the parameter extraction unit extracts the second parameter without restricting an arranging position of the calibration marker within the common field of view.

13. The vehicle according to claim 8,
wherein the calibration marker is a calibration pattern having a known configuration,
wherein the parameter extraction unit includes a first parameter correction unit for correcting the first parameter based on a captured result of the calibration pattern having the known configuration by the reference camera, and
wherein the parameter extraction unit obtains the second parameter using the first parameter corrected by the first parameter correction unit.

14. The vehicle according to claim 13,
wherein the known calibration pattern has a square configuration and four vertices of the square configuration are utilized for calibration as four feature points.

15. A camera calibration method for obtaining parameters for projecting captured images from a plurality of cameras on a predetermined plane and synthesizing the captured images, comprising the steps of:
obtaining a first parameter for a reference camera based on known setup information, the reference camera being one of the plurality of cameras; and
obtaining a second parameter for a non-reference camera, the non-reference camera being another of the plurality of cameras,
wherein the second parameter for the non-reference camera is obtained based on the first parameter and captured results of a calibration marker by the reference camera and by the non-reference camera, the calibration marker being located within a common field of view of the reference camera and the non-reference camera.

16. The camera calibration method according to claim 15, wherein the first parameter is obtained based on a perspective projection transformation using the known setup information.

17. The camera calibration method according to claim 15,
wherein the calibration marker provides at least four feature points within the common field of view, and
wherein the second parameter is obtained based on a captured result of each of the feature points by the reference camera, a captured result of each of the feature points by the non-reference camera, and the first parameter.

18. The camera calibration method according to claim 17, wherein the second parameter is obtained by a planar projective transformation based on coordinate values of a captured result of each of the feature points by the non-reference camera, and coordinate values of a captured result of each of the feature points by the reference camera that have been converted using the first parameter.

19. The camera calibration method according to claim 15, wherein the second parameter is obtained without restricting an arranging position of the calibration marker within the common field of view.

20. The camera calibration method according to claim 15,
wherein the calibration marker is a calibration pattern having a known configuration,
wherein the camera calibration method further comprises correcting the first parameter based on a captured result of the calibration pattern having the known configuration by the reference camera, and obtaining the second parameter using the first parameter thus corrected.

21. The camera calibration method according to claim 20,
wherein the known calibration pattern has a square configuration and four vertices of the square configuration are utilized for calibration as four feature points.
